(19) United States
(12) Patent Application Publication
(10) Pub. No.: US 2011/0100321 A1
(43) Pub. Date: May 5, 2011

(54) ROTARY POWER DEVICE

(76) Inventors: Manousos Pattakos, Nikea Piraeus (GR); Argyro Pattakou, Athens (GR); Emmanouel Pattakos, Nikea Piraeus (GR)

(21) Appl. No.: 12/611,104

(22) Filed: Nov. 2, 2009

(51) Int. Cl. F02B 53/00; F04C 2/063; F01C 1/063

(52) U.S. Cl. 123/200; 418/35

(57) ABSTRACT

A rotary power device comprising: a toroidal cavity, an inclined power shaft, two rotors carrying pistons and two concentric Cardan joints.

The Cardan joints interconnect the power shaft with the rotors. The power shaft and the two Cardan joints are disposed away from the toroidal cavity in order their dimensions, hence their strength are not limited by the geometry of the toroidal cavity. Variable displacement engines and variable capacity pumps are optional.

It concerns an improved rotary power device.

The U.S. Pat. No. 4,086,879 is the closest prior art.

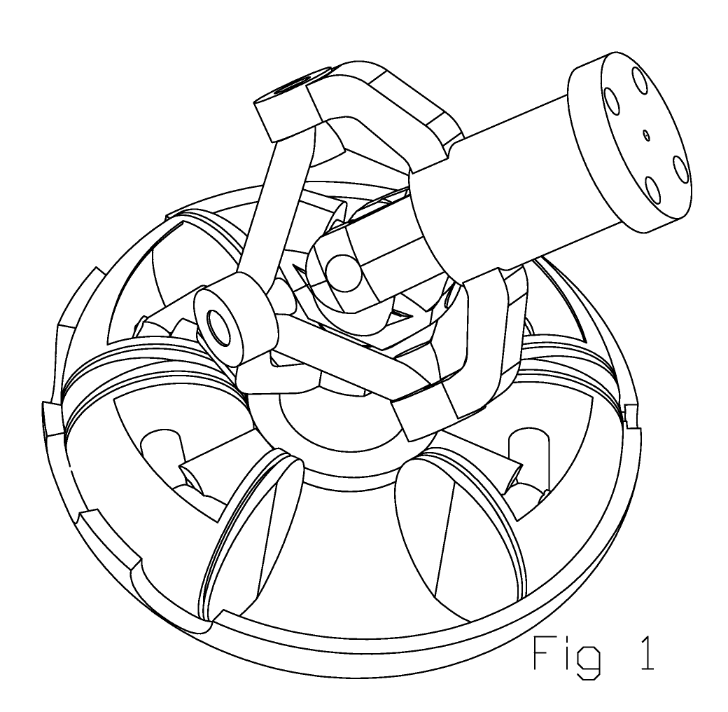

FIG. 1 shows the moving parts and half of the toroidal cavity of the first preferred embodiment.

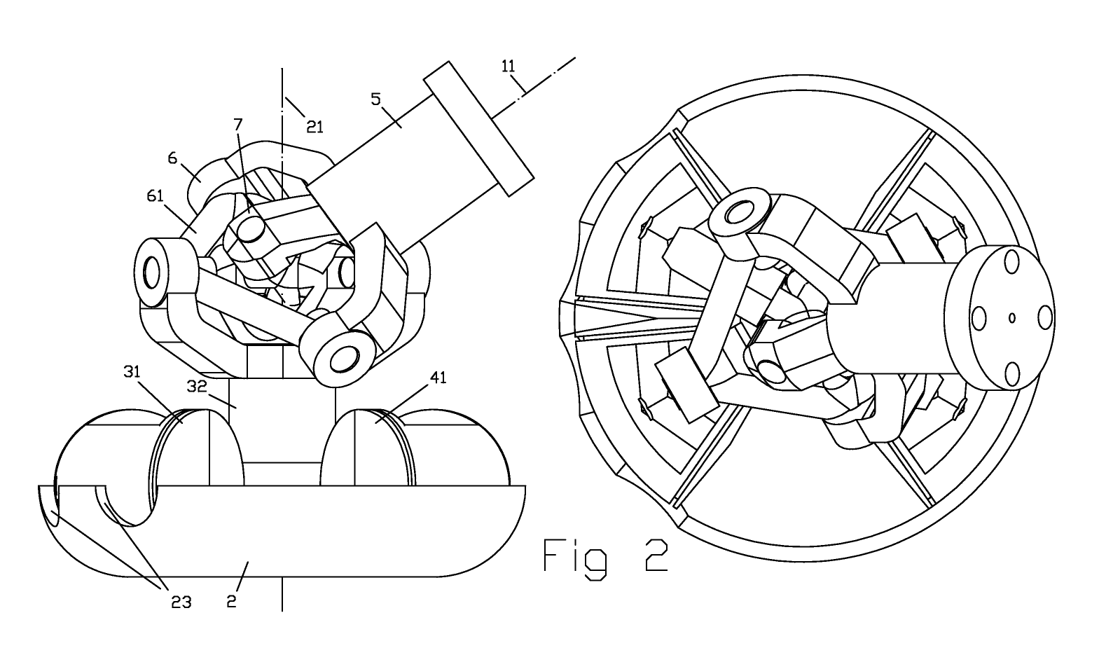

FIG. 2 shows what FIG. 1 from two different viewpoints.

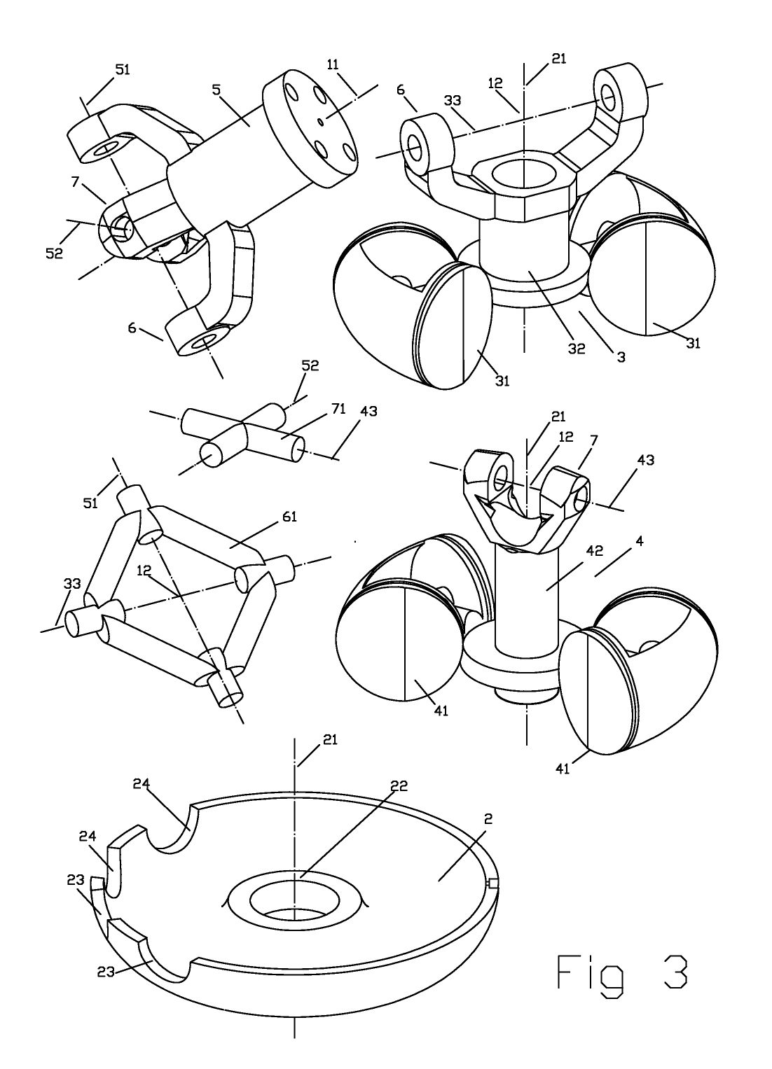

FIG. 3 shows the mechanism of FIG. 1 exploded.

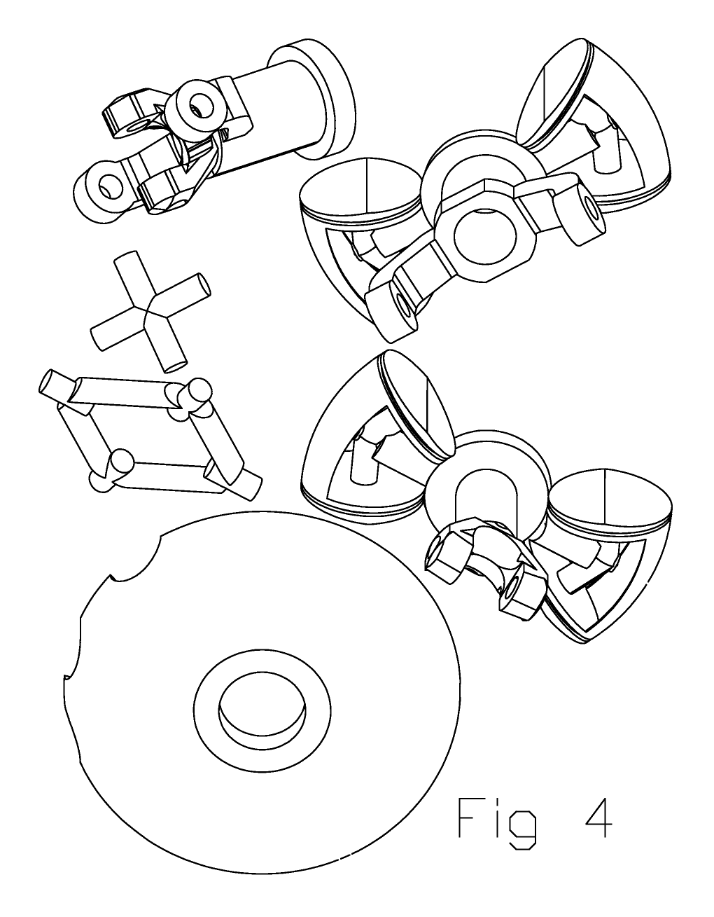

FIG. 4 shows the parts of FIG. 3 from a different viewpoint.

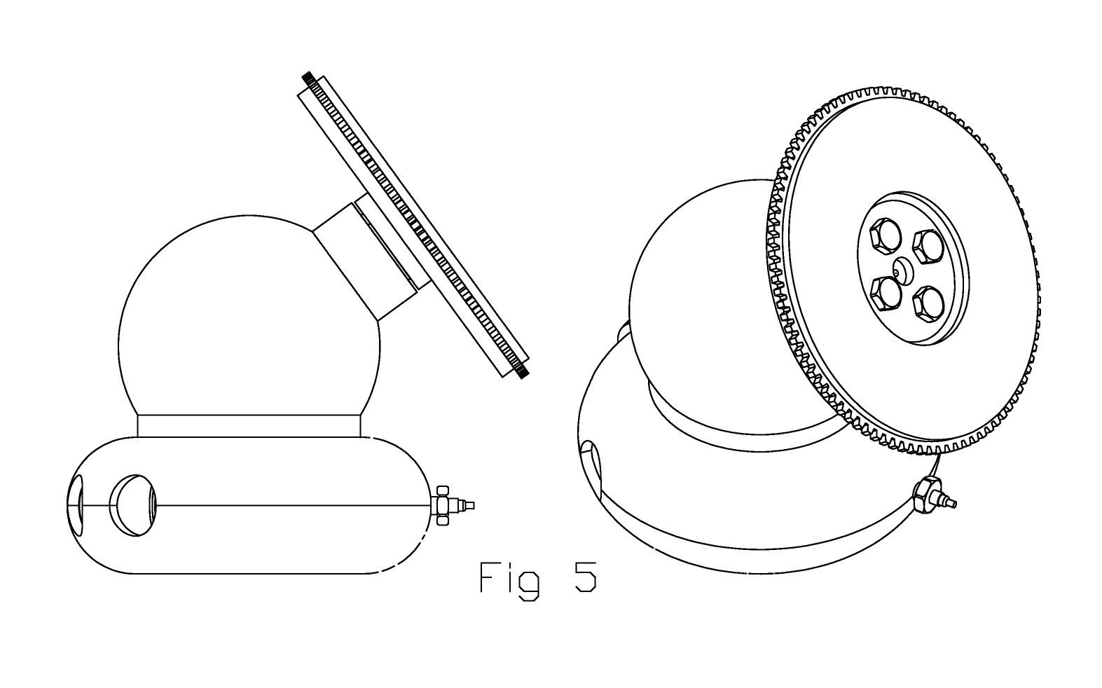

FIG. 5 shows, from two different viewpoints, the first preferred embodiment with the casing and the flywheel.

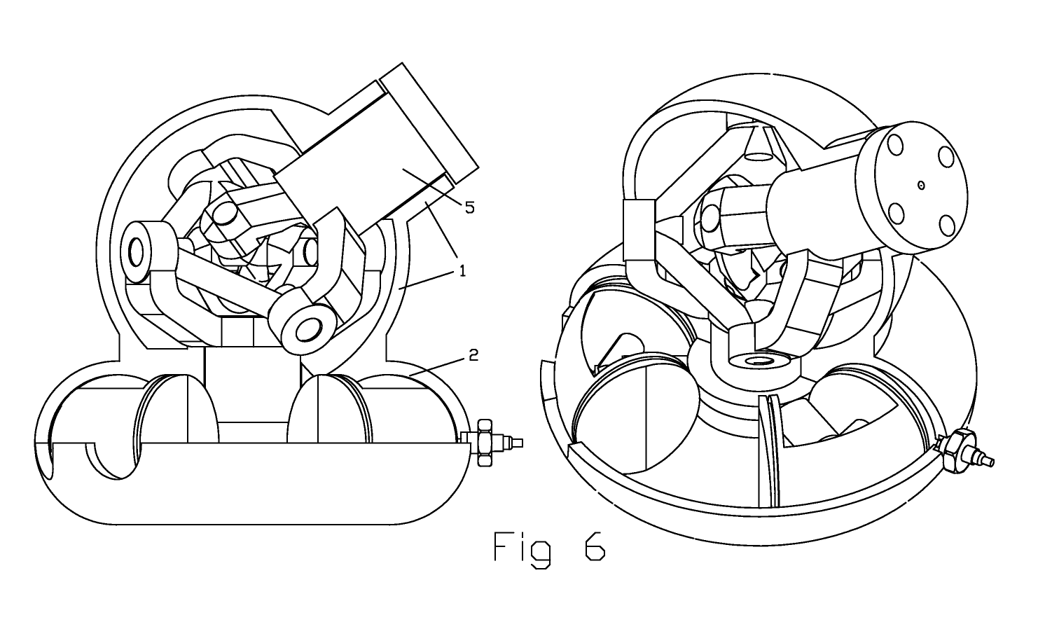

FIG. 6 shows what FIG. 5 with the casing sliced and the flywheel removed.

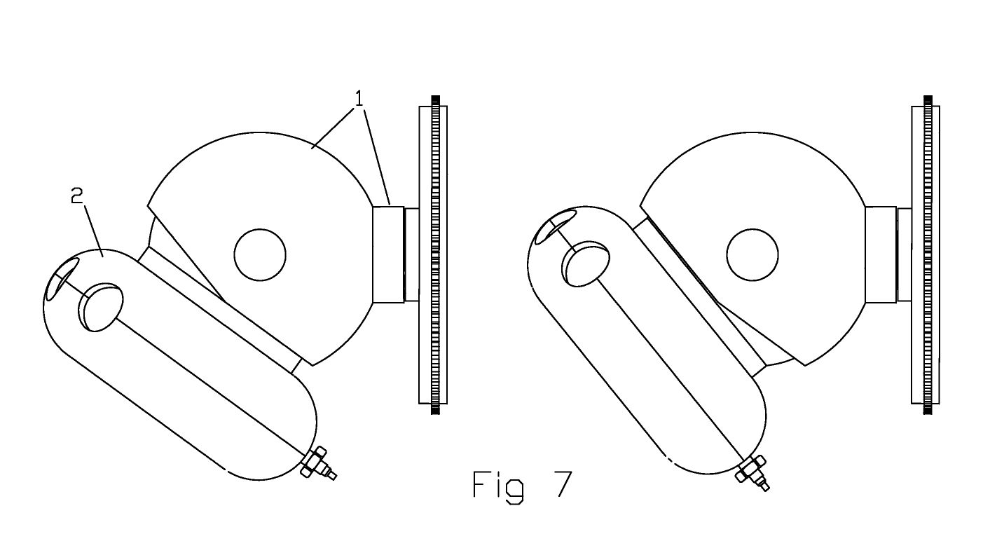

FIG. 7 shows the second preferred embodiment wherein the rotary engine of the first preferred embodiment is modified to a variable compression and variable displacement engine. At left the engine is shown at high compression ratio and high displacement, at right the engine is shown at low compression ratio and small displacement.

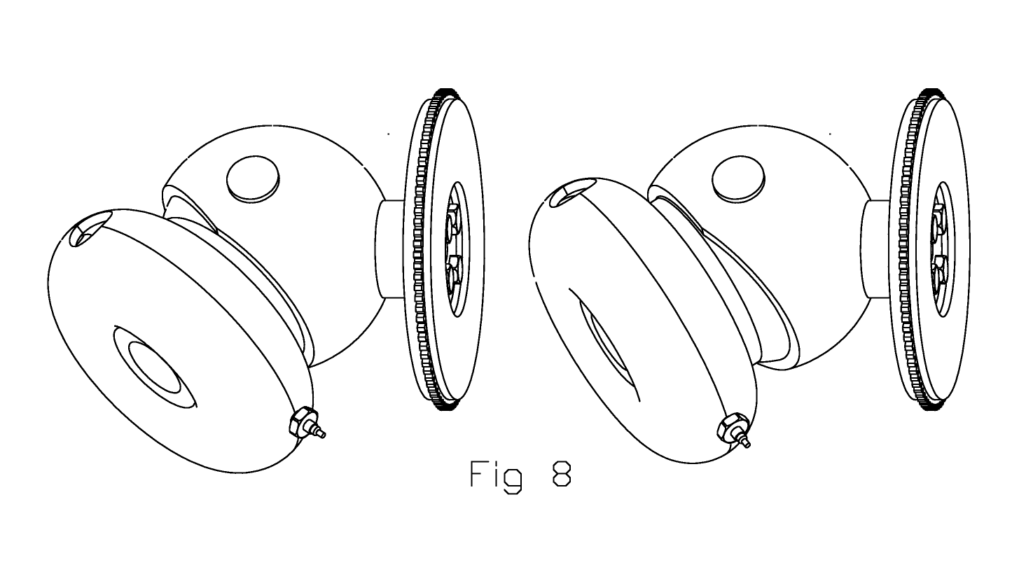

FIG. 8 shows what FIG. 7 from a different viewpoint.

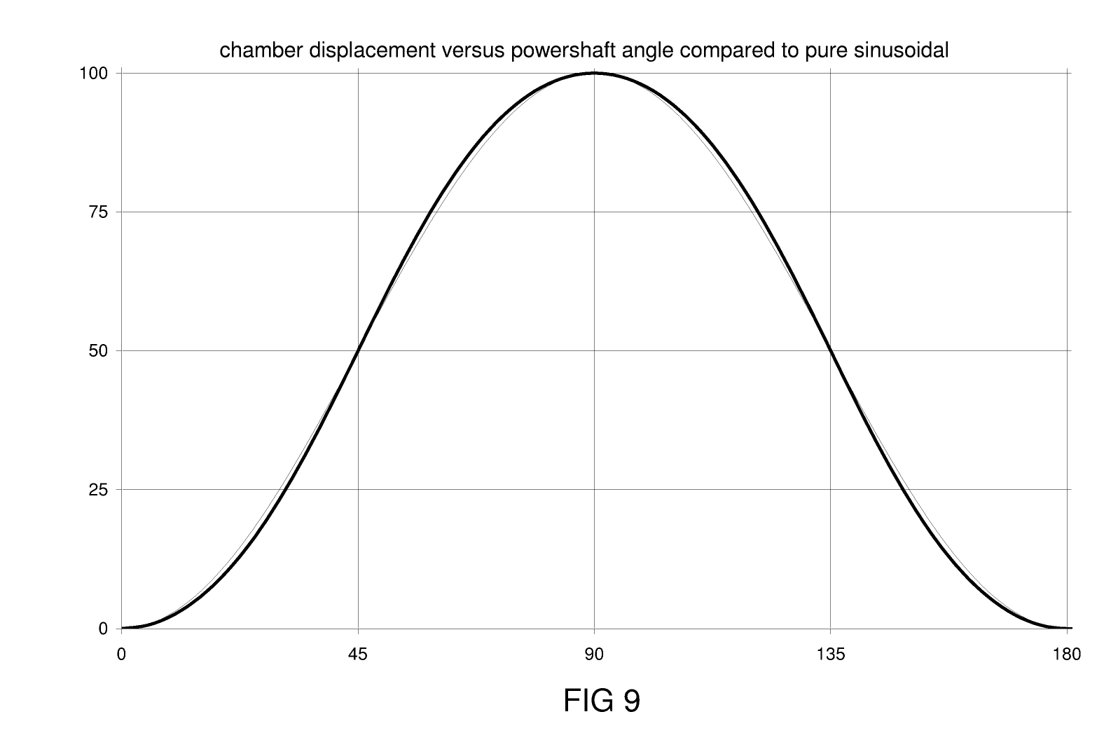

FIG. 9 is a plot of the chamber displacement versus the power shaft angle.

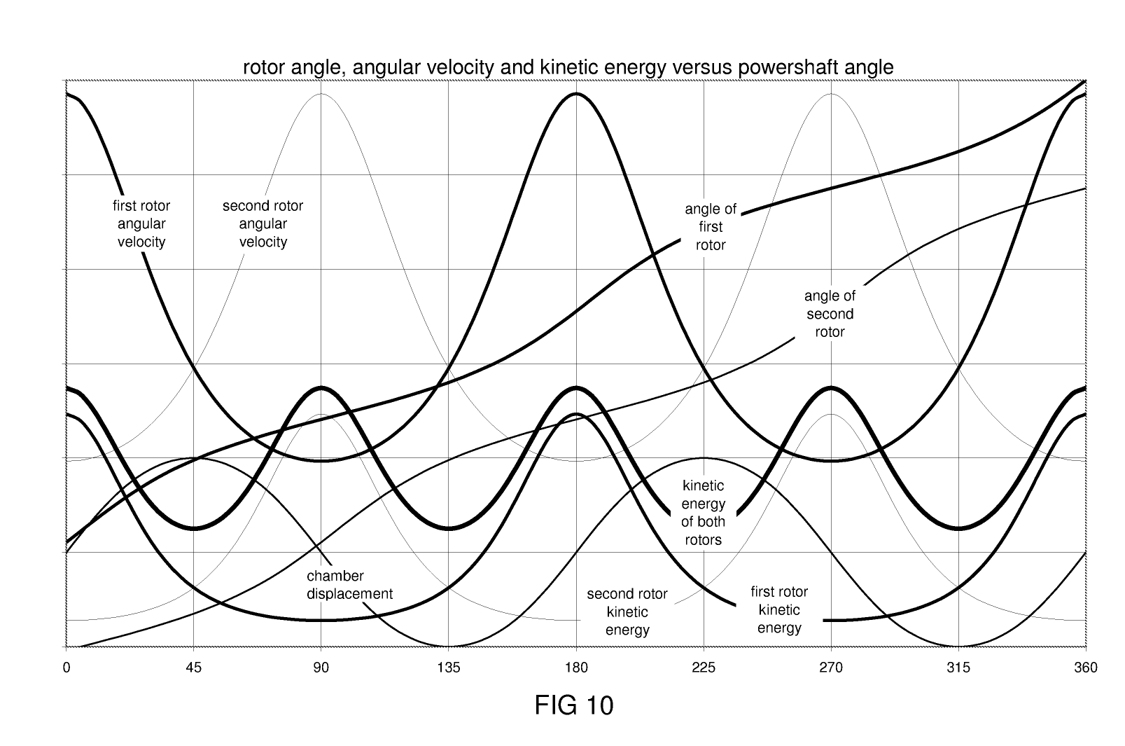

FIG. 10 is a plot of the rotor angle, of the rotor angular velocity and of the rotor kinetic energy versus the power shaft angle.

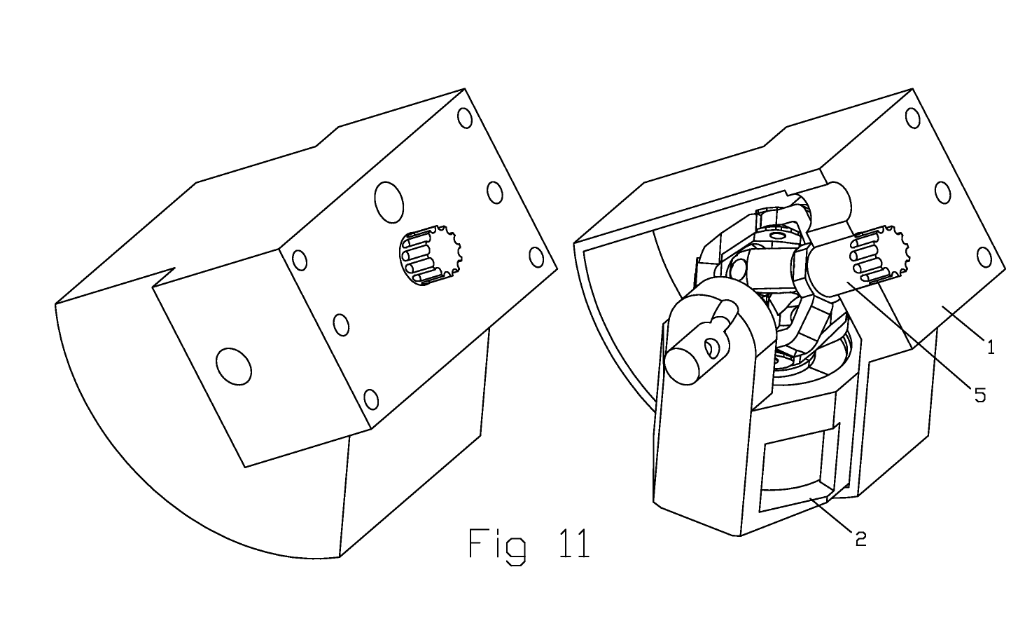

FIG. 11 shows a rotary pump based on the same principle. At right the pump casing is sliced to show internal details.

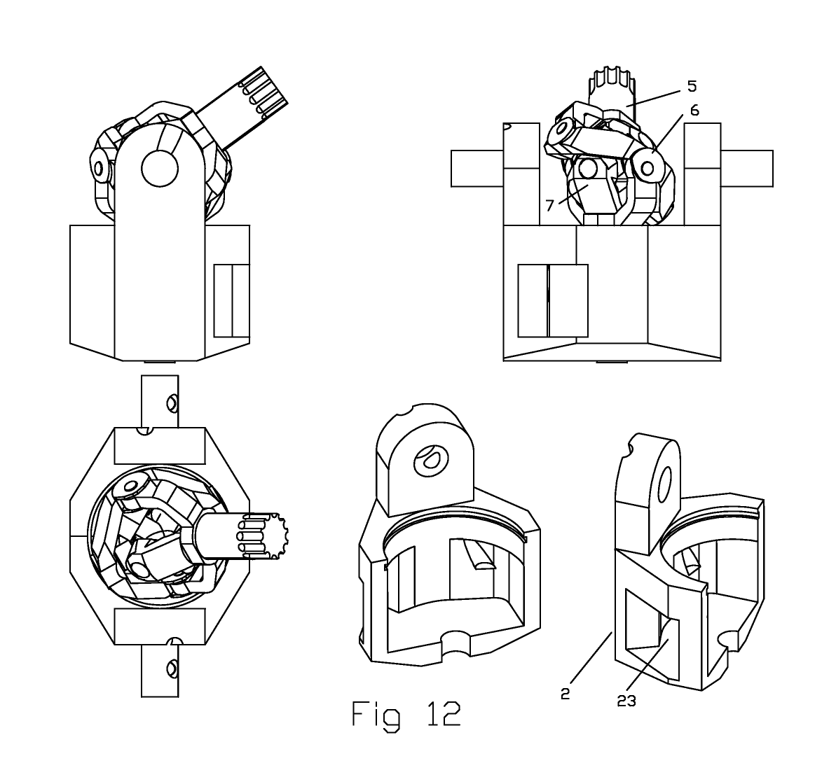

FIG. 12 shows, from three different viewpoints, the pump of FIG. 11 with the casing removed. At bottom right it is shown, from two different viewpoints, the toroidal cavity of the pump sliced.

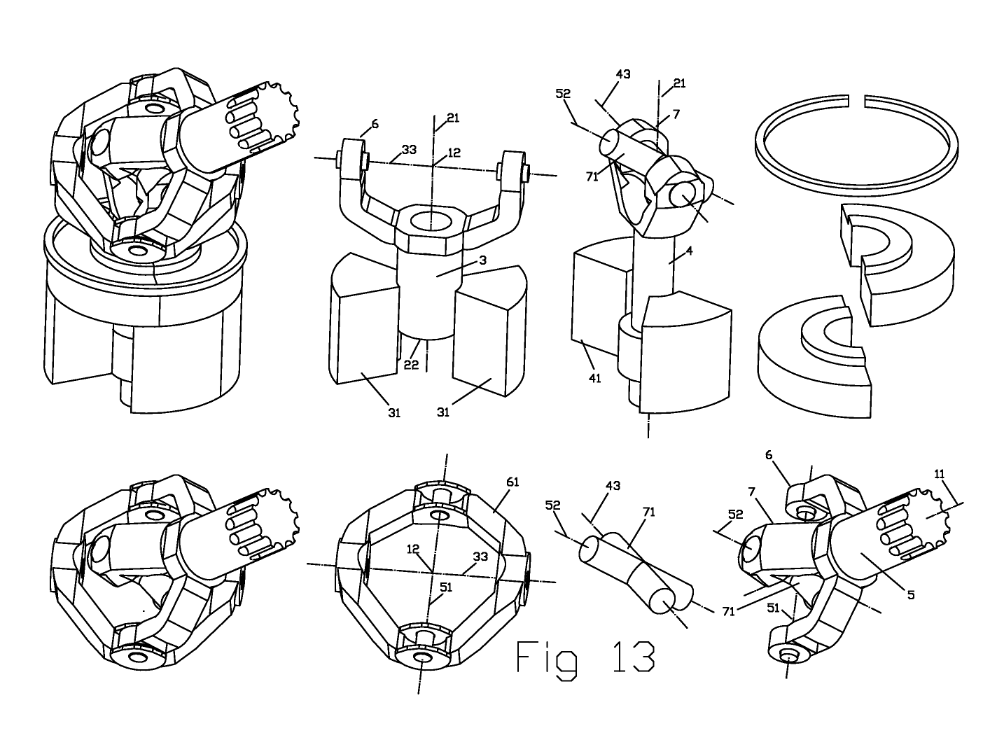

FIG. 13 shows, at top left, the mechanism of the pump of FIG. 11, with the casing and the toroidal cavity removed. FIG. 13 also shows the parts of the mechanism.

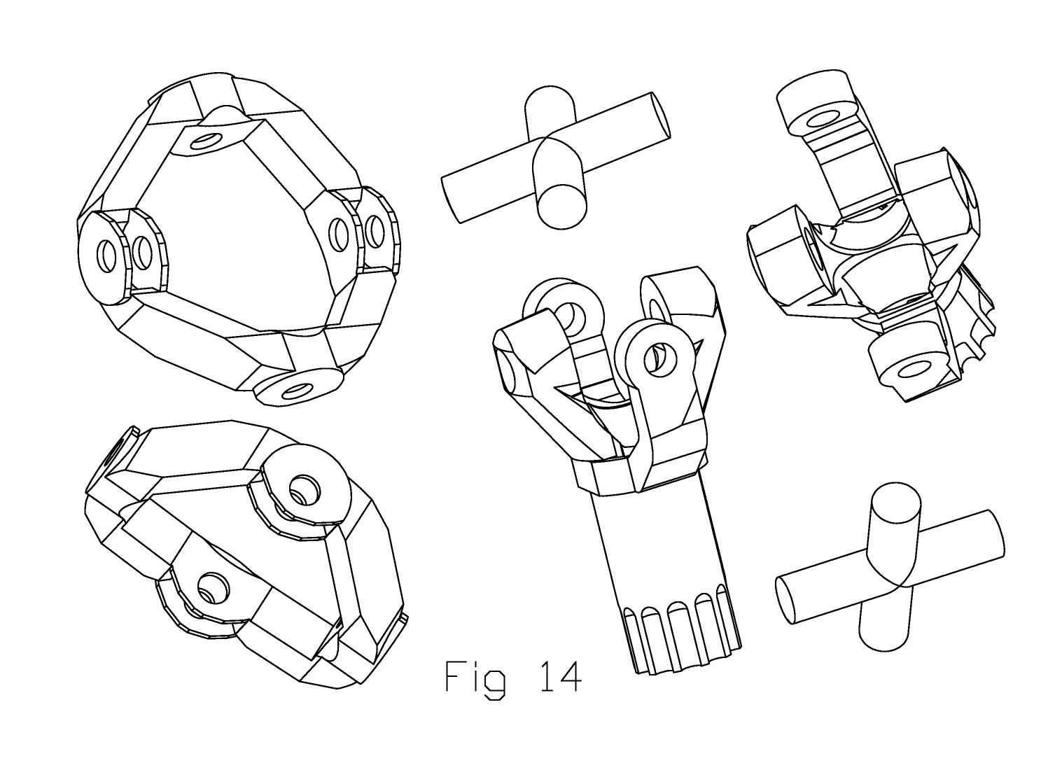

FIG. 14 shows, from two different viewpoints, the power shaft, the cross-like yoke and the ring-like yoke. It also shows how both Cardan joints can have robust structure of similar torque strength, despite the one is into the other.

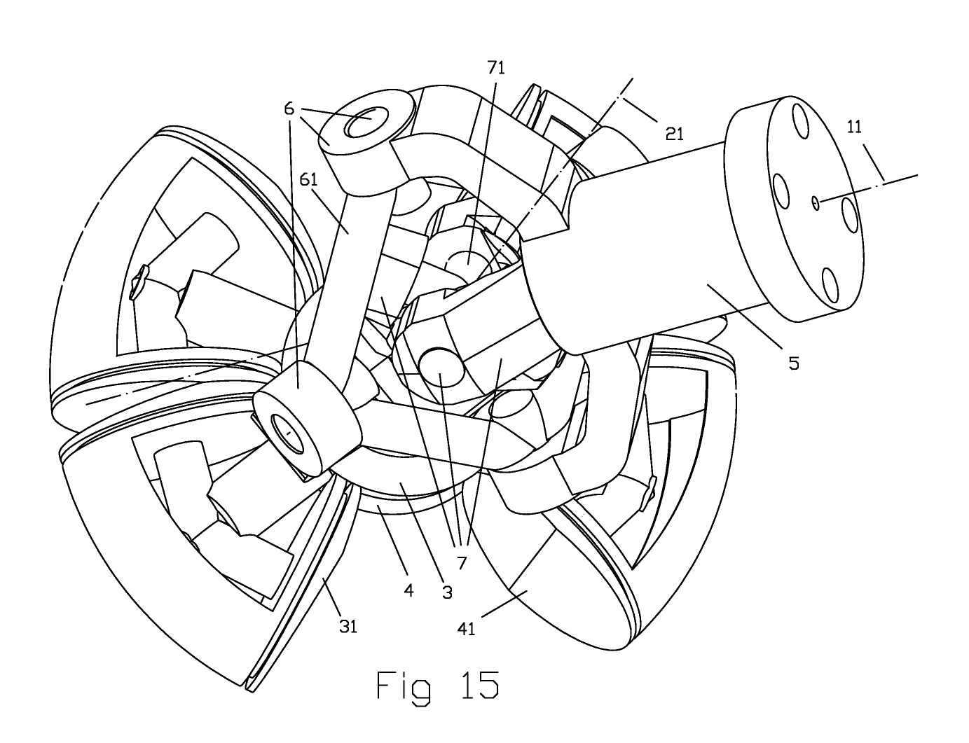

FIG. 15 shows the moving parts of the first preferred embodiment. In a first preferred embodiment, FIGS. 1 to 6 and 15, the rotary power device is an engine comprising a casing 1, a toroidal cavity 2 having openings for intake 23 and exhaust 24, a power shaft 5 and two rotors 3 and 4.

The first rotor 3 comprises a rotor shaft 32, rotatable about the axis 21 of the toroidal cavity 2, and pistons 31 fitted into the toroidal cavity 2.

The second rotor 4 comprises a rotor shaft 42, rotatable about the axis 21 of the toroidal cavity 2, and pistons 41 fitted into the toroidal cavity 2.

The power shaft 5 is oblique, i.e. at an angle, to the toroidal cavity axis 21 and substantially away from the center 22 of the toroidal cavity. The center 22 of the toroidal cavity is its geometrical “center of gravity”.

Two concentric Cardan joints interconnect the power shaft 5 with the rotor shafts 3 and 4. The two Cardan joints are located at one side, away from the toroidal cavity center, in order to be adequately strong for the resulting loads, without limitations from the toroidal cavity geometry.

The Cardan joint 6 comprises a yoke 61 pivotally mounted on the rotor shaft 3 and pivotally mounted on the power shaft 5.

The Cardan joint 7 comprises a yoke 71 pivotally mounted on the rotor shaft 4 and pivotally mounted on the power shaft 5.

The rotation of the power shaft 5 with constant angular velocity causes the rotation of the two rotors 3 and 4 with substantially variable angular velocities, as shown in FIG. 10. The pistons 31 and 41 of the two rotors orbit about the toroidal cavity axis 21, approaching and moving away from each other two times per power shaft rotation. This way, four independent chambers into the toroidal cavity are formed. The chamber displacement versus the power shaft angle is shown in FIG. 9, where the pure sinusoidal curve is added for comparison. According this plot, after TDC, i.e. the point where the chamber takes its minimum displacement, the expansion rate is a little slower than sinusoidal, while in the conventional reciprocating engine the expansion rate after TDC is significantly faster than sinusoidal. I.e. the toroidal engine increases the constant volume portion of the expansion cycle and provides more time to the fuel for efficient combustion.

The intake cycle starts when a chamber has its minimum displacement and communicates, through the intake port, to the intake manifold. As the power shaft rotates, the displacement of the chamber gradually increases suctioning air or mixture. With the chamber near its maximum displacement, its contact with the intake port ends and the charge is trapped. As the power shaft rotates further, the volume is reduced and the charge into the chamber is compressed. The combustion starts with the chamber near its minimum displacement (some 180 power shaft degrees after the suction started). Further rotation of the power shaft increases the volume of the chamber making the expansion cycle or power stroke. With the volume of the chamber near its maximum, the chamber starts communicating with the exhaust manifold through the exhaust port. Further rotation of the power shaft reduces the volume of the chamber and expels the exhaust gas out of it. As the volume of the chamber gets near to its minimum, the chamber loses contact to the exhaust port and gets contact to the intake port to repeat the cycle.

In order to achieve wider variation of the angle between the two rotors, for instance from 60 to 120 degrees, it is necessary a wider angle between the toroidal cavity axis and the rotation axis of the power shaft, for instance 55 degrees.

This way the chambers become less “oversquare” and occupy a bigger percentage of the toroidal cavity volume.

Each combustion chamber is sealed by two rotating/oscillating pistons, the first secured on the first rotor, the second secured on the second rotor. The force on the first piston multiplied by the constant, and inevitably long, eccentricity of the first piston from the toroidal cavity axis is the torque that loads the first rotor shaft. A force of equal strength is applied on the second piston and creates an equal and opposite torque on the second rotor shaft. Besides the torque caused by the gas pressure, the rotor shaft carries also the inertia torque generated by the variable angular velocity of the rotor about the toroidal cavity axis.

The power shaft receives, from each of the two rotor shafts, a torque and passes their difference to the flywheel and then to the load.

The toroidal rotary engine has several advantages: simplicity, riddance of valves, four-cycle aspiration, compact and efficient combustion chamber, lightweight, compactness, smoothness etc.

Its Achilles' heel is the mechanism interconnecting the rotating/oscillating pistons to the power shaft.

The problem is that for equal piston diameters, the torque on the crankshaft of the conventional engine is way lower as compared to the torque on each rotor shaft of the toroidal rotary engine. This is because of the long, and constant, eccentricity of the piston of the toroidal rotary engine, making crucial the use of massive and robust “mechanism” between the power shaft and the rotor shafts. The two concentric Cardan joints that interconnect the power shaft with the two rotors are disposed out of the toroidal cavity, exclusively at one side of the toroidal cavity, so that the toroidal cavity poses no limits on their dimensions and strength, while the casing needs be strong only at the one side of the toroidal cavity. The yoke, or like-yoke, mechanism between a rotor and the oblique power shaft generates on the rotor a strong parasitic/idle moment, or thrusting pair of forces, on a plane containing the axis of the toroidal cavity. Without a strong rotor shaft of adequate length, it is quite difficult, if not impossible, to support such thrust moment. This is the case in arrangements like those proposed in U.S. Pat. No. 3,899,269, U.S. Pat. No. 2,253,445 and U.S. Pat. No. 4,949,688 comprising oblique power shaft passing through the center of the toroidal cavity. In these patents the interconnecting mechanism between the power shaft and the rotors is constrained into the limited space at the center of the toroid, hence being inevitably of limited strength. Also the fact that the inner edges of the toroidal cannot be directly bridged/secured to each other, make them incapable of receiving the strong bending moment generated by the interconnecting mechanism. It is like levering a lever between the teeth of two closed jaws. The limited strength of the interconnecting mechanism, the increased friction caused by the strong bending moments applied by the rotors on the toroidal cavity inner edges and the deformation of the toroidal cavity render such arrangements unsuccessful.

Besides the strength of the mechanism it is also the simplicity. In the present invention the number of the parts is kept at minimum: besides the power shaft and the two rotors met in the toroidal rotary engines of the art, all it takes is two “yokes”. In comparison, the arrangement proposed in U.S. Pat. No. 4,174,930 comprises, besides the parts of this invention, a differential-like gear box and other additional parts that increase the length, increase the friction and reduce the reliability. Similarly, the arrangement of U.S. Pat. No. 4,086,879 comprises two additional rotating shafts at the two sides of the toroidal cavity, and the engine casing needs to have strong structure at both sides of the toroidal cavity.

Unlike the conventional reciprocating engine, where the pistons are supported and guided by the cylinder wall, in the reciprocating piston engine of PCT/EP2007/050809 the pistons need not touch the walls, allowing the cross section of the cylinder bore being machined a little wider towards the ports, in order to reduce the sealing means friction and to improve the control over the lubricant by reducing the lubricant quantity that reaches the ports. Likewise in engines of this invention, since the pistons do not need to touch the toroidal cavity, the cavity can be machined with a wider cross section near the ports in order to optimize the pressing of the rings and to reduce the quantity of the lubricant that reaches the ports, especially at the overheated bridges of the exhaust ports and get burned or passes into the exhaust.

The drawings and the analysis make it clear that another principal problem of the motion converting mechanism of these engines is the heavier twisting moments, i.e. torques, the two rotor shafts and the crosses undergo. And whatever limits their dimensions make them unreliable.

In a second preferred embodiment, shown in FIGS. 7 and 8, the rotary engine of the first preferred embodiment is modified to a continuously variable compression and continuously variable displacement rotary engine. The toroidal cavity is pivotally mounted on the casing at a pivot axis passing through the common center of the two Cardan joints. A wider angle between the toroidal cavity axis 21 and the rotation axis 11 of the power shaft increases the compression ratio and the displacement of the rotary engine.

If the pivot axis is not perpendicular to the plane defined by the power shaft axis and the toroidal cavity axis, besides the variation of the compression ratio and of the displacement, the rotation of the toroidal cavity varies also the phase of the chamber relative to the ports and to the spark plug/injector.

The right angle between the two pivot axes of a yoke is not obligatory.

In a third preferred embodiment, shown in FIGS. 11 to 14, the rotary power device is a pump or compressor. The shape of the toroidal cavity is different than that of the toroidal cavity of the first preferred embodiment, yet their mechanisms are similar. In the casing shown in FIG. 11, the big hole above the power shaft is the inlet port, while the two holes at left and right of the power shaft are the discharge ports. The other four holes are for the mounting of the pump.

The fluid, liquid or gaseous, is suctioned by two intake ports of the toroidal cavity, some 180 degrees away from each other, and is discharged under pressure through two discharge ports of the toroidal cavity, also some 180 degrees away from each other. The same pump may serve two separate circuits. For instance, if the pump is used as an artificial heart to pump the blood of a patient, blood from the body, poor in O2, is suctioned through the first intake port, this blood leaves the pump through the first discharge port to the lugs, blood from the lugs, rich in O2, is suctioned by the second intake port and leaves the pump, through the second discharge port, to the body under pressure.

In a fourth preferred embodiment, the pump of the third preferred embodiment is modified to a continuously variable capacity pump. The toroidal cavity of the pump is pivotally mounted on the casing of the pump at a pivot axis passing through the center of both Cardan joints. Changing the angle between the axis of the toroidal cavity and the axis of the power shaft, the capacity varies from zero to a maximum. If it is used as the oil pump for the lubrication of a reciprocating engine, the variable capacity controls the oil pressure at the desirable level, avoiding the energy loss in the waste/“relief valve” of the conventional oil pumps. The simplest control is a restoring spring between the casing and the toroidal cavity: at high volume the pressure tends to increase, the toroidal cavity presses heavier the restoring spring, the angle between the power shaft and the rotor shafts decreases and so the volume is reduced and the discharge pressure is kept within the desirable limits without a relief valve.

What is claimed is:

1. A rotary engine comprising at least:
a casing (1);
a toroidal cavity (2) having a toroidal cavity axis (21) and a toroidal cavity center (22) at the geometrical center of gravity of the toroidal cavity (2), said toroidal cavity (2) having intake port openings (23) and exhaust port openings (24);
a first rotor (3) comprising pistons (31) fitted into said toroidal cavity (2), said first rotor (3) comprising a first rotor shaft (32) rotatably mounted to rotate about said toroidal cavity axis (21);
a second rotor (4) comprising pistons (41) fitted into said toroidal cavity (2), said second rotor (4) comprising a second rotor shaft (42) rotatably mounted to rotate about said toroidal cavity axis (21);
a power shaft (5) rotatably mounted on said casing (1) to rotate about an axis (11) of said casing (1), said axis (11) intersecting the toroidal cavity axis (21) at a center (12) substantially away from said toroidal cavity center (22), said axis (11) being substantially oblique to said toroidal cavity axis (21);
a first Cardan joint (6) interconnecting said power shaft (5) with said first rotor shaft (32), said first Cardan joint (6) comprising a first yoke (61) pivotally mounted on said power shaft (5) at a power shaft first pivot axis (51), said first yoke (61) being pivotally mounted on said first rotor shaft (32) at a first rotor shaft pivot axis (33), said power shaft first pivot axis (51) intersecting said first rotor shaft pivot axis (33) at said center 12;
a second Cardan joint (7) interconnecting said power shaft (5) to said second rotor shaft (42), said second Cardan joint (7) comprising a second yoke (71) pivotally mounted on said power shaft (5) at a power shaft second pivot axis (52), said second yoke (71) being pivotally mounted on said second rotor shaft (42) at a second rotor shaft pivot axis (43), said power shaft second pivot axis (52) intersecting said second rotor shaft pivot axis (43) at said center 12,
the first and the second rotor shafts extend substantially away from the toroidal cavity center, being properly borne to receive at small friction the heavy torques generated from their cooperation with the power shaft by the first and the second Cardan joints, the power shaft, the first and the second Cardan joints are disposed exclusively at one side of the toroidal cavity, substantially away from the toroidal cavity center, so that their size and strength are not limited by the geometry of the toroidal cavity.

2. A rotary engine according 1 wherein the toroidal cavity (2) is rotatable relative to the casing (1) about the center (12) to provide variable displacement and variable compression ratio.

3. A rotary engine according claim 1 wherein the angle between the power shaft first pivot axis (51) and the first rotor shaft pivot axis (33) either the angle between the power shaft second pivot axis (52) and the second rotor shaft pivot axis (43) or both are not right angles.

4. A rotary pump comprising at least:
a casing (1);
a toroidal cavity (2) having a toroidal cavity axis (21) and a toroidal cavity center (22) at the geometrical center of gravity of the toroidal cavity (2), said toroidal cavity (2) having intake port openings (23) and exhaust port openings (24);
a first rotor (3) comprising pistons (31) fitted into said toroidal cavity (2), said first rotor (3) comprising a first rotor shaft (32) rotatably mounted to rotate about said toroidal cavity axis (21);
a second rotor (4) comprising pistons (41) fitted into said toroidal cavity (2), said second rotor (4) comprising a second rotor shaft (42) rotatably mounted to rotate about said toroidal cavity axis (21);
a power shaft (5) rotatably mounted on said casing (1) to rotate about an axis (11) of said casing (1), said axis (11) intersecting the toroidal cavity axis (21) at a center (12) substantially away from said toroidal cavity center (22), said axis (11) being substantially oblique to said toroidal cavity axis (21);
a first Cardan joint (6) interconnecting said power shaft (5) with said first rotor shaft (32), said first Cardan joint (6) comprising a first yoke (61) pivotally mounted on said power shaft (5) at a power shaft first pivot axis (51), said first yoke (61) being pivotally mounted on said first rotor shaft (32) at a first rotor shaft pivot axis (33), said power shaft first pivot axis (51) intersecting said first rotor shaft pivot axis (33) at said center 12;
a second Cardan joint (7) interconnecting said power shaft (5) to said second rotor shaft (42), said second Cardan joint (7) comprising a second yoke (71) pivotally mounted on said power shaft (5) at a power shaft second pivot axis (52), said second yoke (71) being pivotally mounted on said second rotor shaft (42) at a second rotor shaft pivot axis (43), said power shaft second pivot axis (52) intersecting said second rotor shaft pivot axis (43) at said center 12,
the power shaft, the first and the second Cardan joints are disposed exclusively at one side of the toroidal cavity, substantially away from the toroidal cavity center, so that their size and strength are not limited by the geometry of the toroidal cavity.

5. A rotary pump according claim 4 wherein the toroidal cavity (2) is rotatable relative to the casing (1) about the center point (12) to provide variable capacity.

6. A rotary pump according claim 4 wherein the angle between the power shaft first pivot axis (51) and the first rotor shaft pivot axis (32) either the angle between the power shaft second pivot axis (52) and the second rotor shaft pivot axis (43) or both are not right angles.

7. A rotary power device comprising at least:
a casing;
a toroidal cavity;
two rotors carrying pistons fitted into the toroidal cavity, the two rotors having common rotation axis;
a power shaft substantially inclined to the rotation axis of the two rotors;
two concentric Cardan joints interconnecting directly the power shaft to both rotors,
the power shaft and the Cardan joints are disposed substantially at the one only side of the toroidal cavity.

8. A rotary power device according claim 7 wherein the two concentric Cardan joints have substantially similar torque capacity.

9. A rotary power device according claim 7, wherein the cross section of the toroidal cavity being machined wider near the area of the ports than it is at the area of the combustion chamber for optimized friction and lower lubricant consumption.
